(19) United States
(12) Patent Application Publication
(10) Pub. No.: US 2010/0279249 A1
(43) Pub. Date: Nov. 4, 2010

(54) DENTAL ORAL MIRROR

(76) Inventor: Yan-Zhang LIN, Puli Township (TW)

Correspondence Address: Ching-Ling Huang, 5597 NW 127th Ter, Portland, OR, 97229, US

(21) Appl. No.: 12/434,686

(22) Filed: May 4, 2009

(51) Int. Cl. A61C 3/00

(52) U.S. Cl. 433/30

(57) ABSTRACT

A dental oral mirror has a handgrip with a holding end and a gripping end, and a mirror frame connecting to the holding end. The handgrip and the mirror frame form a selected angle between them. The mirror frame has two opposite holding sides to hold respectively a mirror so that more light reflective angles are provided for dentists during treatment of patients and usability improves. The invention also can reduce wrist turning of the dentists during treatment and protect the wrist and neck of the dentists, and reduce professional injury that might otherwise occur.

### FIELD OF THE INVENTION

The present invention relates to an improved dental diagnosis equipment to reduce professional injury of dentists and particularly to a dental oral mirror that has two-sided mirrors.

### BACKGROUND OF THE INVENTION

Almost all lines of work have some kind of professional injuries, especially on muscles and bones. Medical professionals who dedicate their work on healing other people are no exception. Medical professionals, depending on their different job natures, such as doctors, medical technicians, managers, nurses, administrators and the like, also suffer from different types of physical injuries. One of common injuries occurs to doctors is Neck Shoulder Arm Pain (NSAP). The nurses have to move patients frequently, hence often suffer from lower back pain. The administrators often suffer from carpal tunnel syndrome.

Dentists also often are inflicted by the carpal tunnel syndrome. This is because a dentist's work requires the neck, chest and waist posed in unique postures, thus result in strain and poor coordination of muscles. The tension of wrists increases. Moreover, the dentist has to repeatedly perform improper wrist movements in work. Hence the carpal tunnel syndrome becomes a common professional injury to the dentist.

Oral mirror is equipment frequently used by the dentist. It reflects affected parts of patient's mouth to enable the dentist to make judgment and perform treatment. Referring to FIG. 1, a conventional oral mirror has a mirror frame 1 holding a single mirror 2. When in use, the dentist often has to turn and adjust the angle of the stem 3 to reflect light. Such an adjustment action requires wrist movement and often generates a higher tension on the wrist. To make adjustment to reflect light also often results in sore neck of the dentist. Hence improving the medical equipment frequently used by the dentist to alleviate the professional injury is an issue needed constant attention.

### SUMMARY OF THE INVENTION

The primary object of the present invention is to solve the shortcomings of the conventional oral mirror to reduce wrist injury of dentists and improve practicality.

To achieve the foregoing object, the present invention provides a dental oral mirror which includes a stem-like handgrip with a holding end and a gripping end, and a mirror frame connecting to the holding end. The handgrip and the mirror frame form an angle between them. The mirror frame has two opposite holding sides to hold respectively a mirror.

By means of the construction set forth above, the dental oral mirror of the invention provides at least the following effects and benefits

1. Compared with the conventional dental mirror with only one mirror, the oral mirror of the invention has two-sided mirror to increase light reflective angles when the dentist performs treatment in patient's mouth, hence usability improves.

2. By providing the medical equipment with improved usability, the repetitive and improper wrist movements can be reduced, hence the carpal tunnel syndrome can be alleviated for the dentist. The dentist has a better physical protection and can provide higher medical practice quality to patients.

The foregoing, as well as additional objects, features and advantages of the invention will be more readily apparent from the following detailed description, which proceeds with reference to the accompanying embodiment and drawings. The embodiment serves only for illustrative purpose and is not the limitation of the invention.

### BRIEF DESCRIPTION OF THE DRAWINGS

FIG. 1 is a schematic view of a conventional oral mirror.

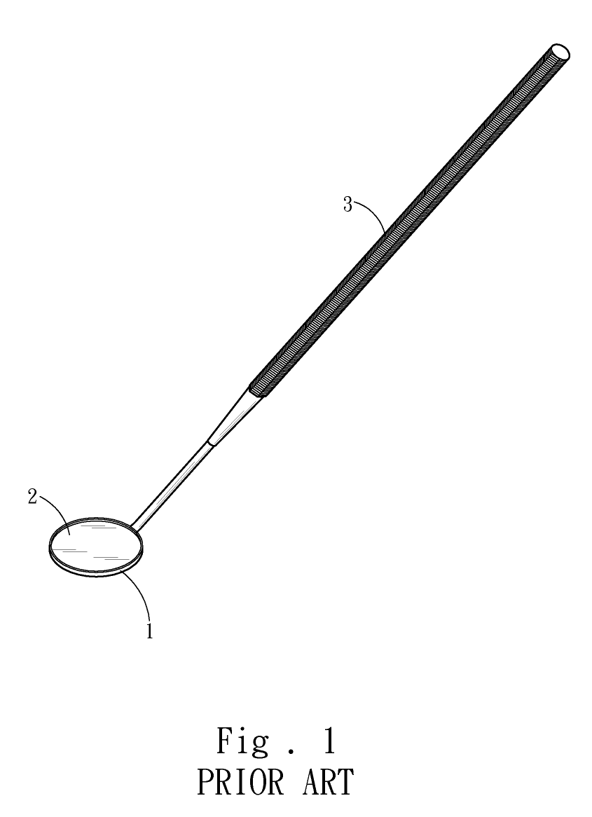

FIG. 2 is a perspective view of the invention.

FIG. 3 is a perspective view of the invention from another angle.

FIG. 4 is a fragmentary sectional view of the invention.

### DETAILED DESCRIPTION OF THE PREFERRED EMBODIMENT

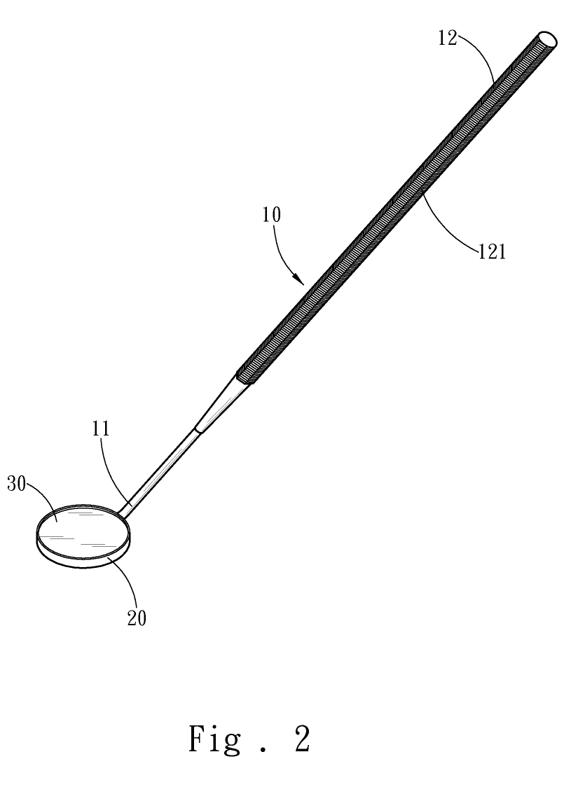

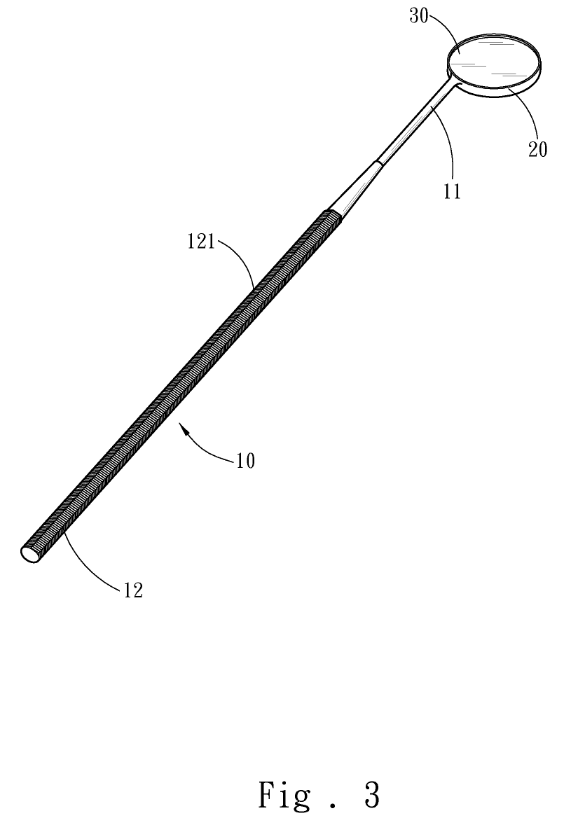

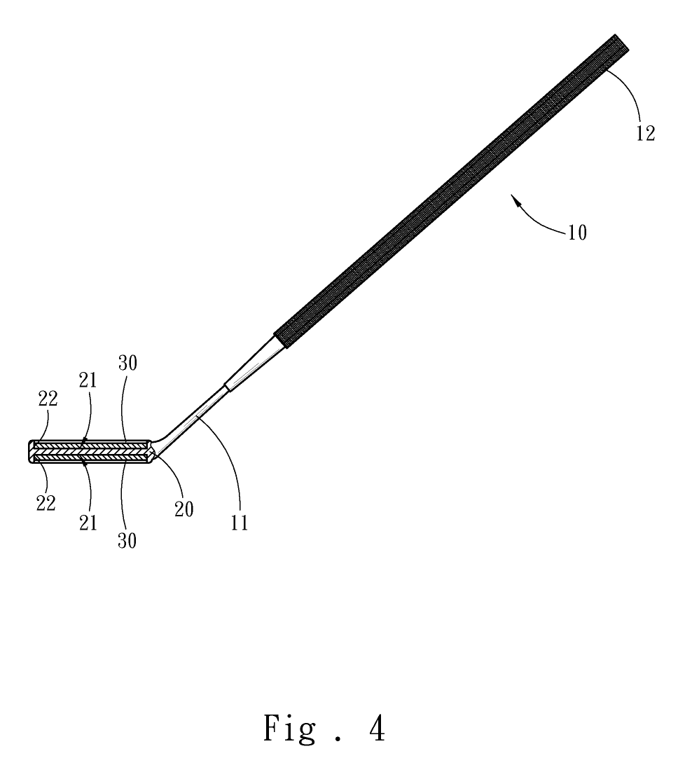

Please refer to FIGS. 2, 3 and 4, the dental oral mirror according to the invention has a stem-like handgrip 10 which includes a holding end 11 and a gripping end 12, and a mirror frame 20 connecting to the holding end 11. The handgrip 10 and the mirror frame 20 form a selected angle between them. The mirror frame 20 has two opposite holding sides 21 each holding a mirror 30. The two holding sides 21 have respectively an indented rim 22 to couple with the mirror 30.

The stem-like handgrip 10 shrinks gradually towards the holding end 11 to reduce visual dead angle. The gripping end 12 has multiple anti-slip traces 121 to facilitate hand gripping.

When in use, the two mirrors 30 on the two holding sides 21 of the mirror frame 20 provide greater usability of angles for dentists when performing treatment in patient's mouth without being restricted in a narrower treatment caused by the conventional single mirror 2. The invention also improves light reflection and practicality.

As a conclusion, the present invention provides improved dental equipment frequently used by dentists. As patient's oral cavity is a small space, doing treatment is a delicate work needs well coordination of dentist's wrist, neck, shoulder, waist and back that is ill-provided by the conventional dental equipment, and results in overtaxing dentist's physical health. This becomes serious as the dentist's workload increases.

The present invention, by providing the mirror frame 20 equipped with two mirrors 30, provides more light reflection angles when the dentist performs treatment in patient's mouth, thus usability improves, and carpal tunnel syndrome that might otherwise inflict the dentist can be reduced. Injury to the wrist and other physical portions of the dentist such as shoulder, neck, chest and waist caused by repetitive improper movements also can be alleviated or prevented. As a result, improved quality of medical treatment can also be provided to the patients.

What is claimed is:

1. A dental oral mirror comprising a stem type handgrip which has a holding end and a gripping end, and a mirror frame connecting to the holding end to form a selected angle with the handgrip, wherein:
the mirror frame has two opposite holding sides each holding a mirror.

2. The dental oral mirror of claim 1, wherein the two holding sides have two opposite indented rims to couple with the two mirrors.

3. The dental oral mirror of claim 1, wherein the gripping end has multiple anti-slip traces formed thereon.

4. The dental oral mirror of claim 1, wherein the stem of the handgrip gradually shrinks towards the holding end.
